(19) United States
(12) Patent Application Publication
(10) Pub. No.: US 2026/0005592 A1
(43) Pub. Date: Jan. 1, 2026

(54) CONTROL DEVICE AND CONTROL PROGRAM PRODUCT FOR POWER CONVERSION CIRCUIT

(71) Applicant: DENSO CORPORATION, Kariya-city (JP)

(72) Inventors: Takahiro OTA, Kariya-city (JP); Kazuma SUZUKI, Nisshin-city (JP)

(73) Assignee: DENSO CORPORATION, Kariya-city (JP)

(21) Appl. No.: 19/321,582

(22) Filed: Sep. 8, 2025

Related U.S. Application Data
(63) Continuation of application No. PCT/JP2024/004694, filed on Feb. 12, 2024.

(30) Foreign Application Priority Data
Mar. 8, 2023 (JP) 2023-035958

(51) Int. Cl. H02M 1/00; H02M 3/158

(52) U.S. Cl. CPC H02M 1/0058; H02M 3/158

(57) ABSTRACT

A control device for a power conversion circuit equipped with a switching circuit includes a switching control unit and a switching unit. The switching control unit controls switching of each semiconductor switching element included in a plurality of legs, and controls a phase difference between a timing of switching to the ON state of a semiconductor switching element included in a reference leg, and a timing of switching to the ON state of a semiconductor switching element included in a residual leg other than the reference leg and belonging to the same arm as the semiconductor switching element included in the reference leg. The switching unit performs switching control to switch a leg including a semiconductor switching element that is first switched to the ON state, every switching period longer than one switching cycle of each semiconductor switching element.

### CROSS-REFERENCE TO RELATED APPLICATION

This application is a continuation application of International Application No. PCT/JP2024/004694 filed Feb. 12, 2024 which designated the U.S. and claims priority to Japanese Patent Application No. 2023-035958 filed Mar. 8, 2023, the contents of each of which are incorporated herein by reference.

### BACKGROUND

### Technical Field

The present disclosure relates to a control device and a control program for a power conversion circuit.

### Related Art

A soft switching converter has been known. The switching circuit of this converter includes switching assemblies PSA1 and PSA2 connected in parallel. In the switching assembly PSA1, a diode FD1, a semiconductor switching element SW1, and an anti-parallel diode APD1 connected in anti-parallel to the semiconductor switching element SW1 are connected in series. In the switching assembly PSA2, a diode FD2, a semiconductor switching element SW2, and an anti-parallel diode APD2 connected in anti-parallel to the semiconductor switching element SW2 are connected in series. One end of a commutation inductor LC1 is connected to a connection point between the diode FD1 and the semiconductor switching element SW1. One end of a commutation inductor LC2 is connected to a connection point between the diode FD2 and the semiconductor switching element SW2. The other end of each of the two commutation inductors LC1 and LC2 is connected to a main inductor LM. The semiconductor switching elements SW1 and SW2 are subjected to switching control with a predetermined phase difference. The resonant operation of the inductors LM, LC1, and LC2 suppresses reverse current in diodes FD1 and FD2, enabling soft switching with reduced switching losses during turn-on of the semiconductor switching elements SW1 and SW2.

### BRIEF DESCRIPTION OF THE DRAWINGS

In the accompanying drawings:

FIG. 1 is a diagram illustrating a power conversion system including a control device of a power conversion circuit according to a first embodiment;

FIG. 2 is a diagram illustrating a drive signal and an element current of each semiconductor switching element provided in the power conversion circuit according to the first embodiment;

FIG. 3 is a diagram illustrating an equal loudness curve;

FIG. 4 is a control flowchart of the power conversion circuit according to the first embodiment;

FIG. 5 is a diagram illustrating a power conversion circuit according to a second embodiment;

FIG. 6 is a diagram illustrating a drive signal and an element current of each semiconductor switching element provided in the power conversion circuit according to the second embodiment;

FIG. 7 is a diagram illustrating a drive signal and an element current of each semiconductor switching element provided in the power conversion circuit according to the second embodiment;

FIG. 8 is a diagram illustrating a power conversion circuit according to a third embodiment;

FIG. 9 is a diagram illustrating an auxiliary reactor according to a modification;

FIG. 10 is a control flowchart of a power conversion circuit according to a modification;

FIG. 11 is a diagram illustrating a positional relationship between an element section and a cooling water flow passage; and

FIG. 12 is a diagram illustrating a positional relationship between an element section and a cooling water flow passage.

### DESCRIPTION OF SPECIFIC EMBODIMENTS

For the purpose of soft switching, as disclosed in Japanese Patent No. 4475676, when one semiconductor switching element is consistently turned on earlier and the other semiconductor switching element is consistently turned on later, the semiconductor switching element turned on earlier carries a larger current for a longer duration than the semiconductor switching element turned on later, thereby resulting in a greater amount of heat generation.

In view of the foregoing, it is desired to have a technology that mitigates uneven heat generation among a plurality of semiconductor switching elements in a power conversion circuit capable of performing soft switching control.

The present disclosure provides a control device for a power conversion circuit. The power conversion circuit is equipped with a switching circuit including a plurality of legs connected in parallel with each other, each of the plurality of legs including an upper-arm element section and a lower-arm element section connected in series to a low side of the upper-arm element section, one element section of the upper-arm element section and the lower-arm element section including a semiconductor switching element and an anti-parallel diode connected in anti-parallel with the semiconductor switching element, and another element section of those upper-arm element section and lower-arm element section including either a semiconductor switching element and an anti-parallel diode or a diode connected in the same direction as the anti-parallel diode, the power conversion circuit being further equipped with a main reactor and an auxiliary reactor, the auxiliary reactor connecting one end of the main reactor and a connection point between the upper-arm element section and the lower-arm element section of at least one of the plurality of legs. The control device includes: a switching control unit configured to perform switching control of the semiconductor switching elements included in the plurality of legs, and to control a phase difference between a switching timing at which the semiconductor switching element included in a reference leg among the plurality of legs is switched to an ON state and a switching timing at which a semiconductor switching element included in each of residual legs other than the reference leg and belonging to the same arm as the semiconductor switching element in the reference leg is switched to the ON state; and a switching unit configured to perform switching control to switch the leg including the semiconductor switching element that is first switched to the ON state, every switching period longer than one switching period of each semiconductor switching element.

In the above control device, the switching control unit performs switching control of each semiconductor switching element included in a plurality of legs provided in the switching circuit portion of the power conversion circuit, and controls a phase difference between a timing of switching to an ON state of a semiconductor switching element included in a reference leg among the plurality of legs, and a timing of switching to an ON state of a semiconductor switching element included in a residual leg other than the reference leg and belonging to the same arm as the semiconductor switching element included in the reference leg. By the control performed by the switching control unit, switching of the semiconductor switching elements can be controlled to achieve soft switching. If the leg including the semiconductor switching element that is first switched to the ON state is fixed, the state in which the amount of heat generation of the semiconductor switching element first switched to the ON state is greater than the amount of heat generation of the other semiconductor switching elements becomes fixed. In contrast, the switching unit executes switching control to switch the leg including the semiconductor switching element that is first switched to the ON state by the switching control unit. By this switching control, it is possible to prevent fixation of a state in which heat generation is concentrated on any one of the semiconductor switching elements included in the plurality of legs. As a result, imbalance in heat generation among the plurality of semiconductor switching elements within the power conversion circuit capable of executing soft switching control can be mitigated.

The present disclosure further provides a control program product for a power conversion circuit. The power conversion circuit is equipped with a switching circuit including a plurality of legs connected in parallel with each other, each of the plurality of legs including an upper-arm element section and a lower-arm element section connected in series to a low side of the upper-arm element section, one element section of the upper-arm element section and the lower-arm element section including a semiconductor switching element and an anti-parallel diode connected in anti-parallel with the semiconductor switching element, and another element section of those upper-arm element section and lower-arm element section including either a semiconductor switching element and an anti-parallel diode or a diode connected in the same direction as the anti-parallel diode, the power conversion circuit being further equipped with a main reactor and an auxiliary reactor, the auxiliary reactor connecting one end of the main reactor and a connection point between the upper-arm element section and the lower-arm element section of at least one of the plurality of legs. The computer program product includes a non-transitory computer readable storage medium having computer readable program embodied therewith, the computer readable program configured to cause a computer to perform: a switching control step of performing switching control of the semiconductor switching elements included in the plurality of legs, and to control a phase difference between a switching timing at which the semiconductor switching element included in a reference leg among the plurality of legs is switched to an ON state and a switching timing at which a semiconductor switching element included in each of residual legs other than the reference leg and belonging to the same arm as the semiconductor switching element in the reference leg is switched to the ON state; and a switching step of performing switching control to switch the leg including the semiconductor switching element that is first switched to the ON state, every switching period longer than one switching period of each semiconductor switching element.

### First Embodiment

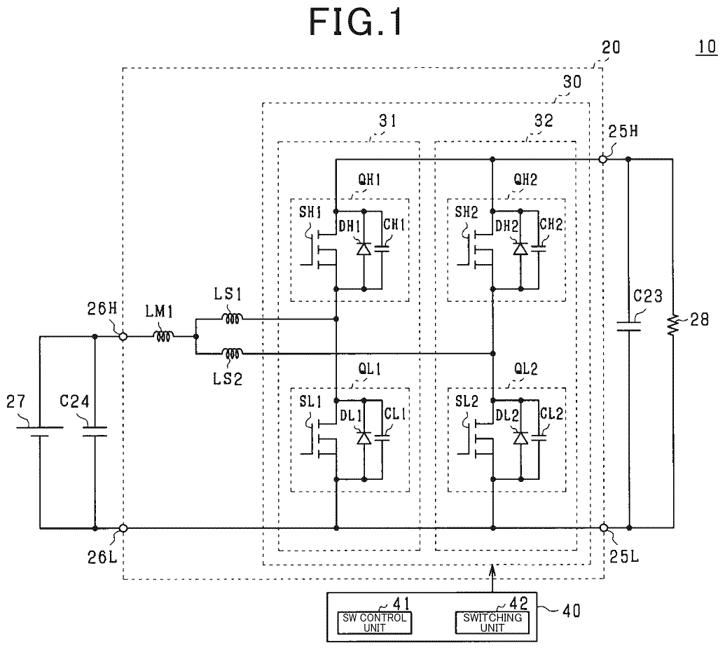

A power conversion system 10 illustrated in FIG. 1 includes a power conversion circuit 20 and a control device 40. The power conversion circuit 20 is a DC-DC converter and includes a switching circuit 30, a main reactor LM1, first and second auxiliary reactors LS1 and LS2, a step-up side high-voltage terminal 25H, a step-up side low-voltage terminal 25L, a step-down side high-voltage terminal 26H, and a step-down side low-voltage terminal 26L. A step-up side capacitor C23 and a load 28 are connected between the step-up side high-voltage terminal 25H and the step-up side low-voltage terminal 25L. A step-down side capacitor C24 and a DC power source 27 are connected between the step-down side high-voltage terminal 26H and the step-down side low-voltage terminal 26L. In the power conversion system 10, the power conversion circuit 20 and the control device 40 function as a step-up converter.

The switching circuit 30 includes a first leg 31 and a second leg 32. The first leg 31 and the second leg 32 are connected in parallel with each other between the step-up side high voltage terminal 25H and the step-up side low voltage terminal 25L, and between the step-down side high voltage terminal 26H and the step-down side low voltage terminal 26L.

The first leg 31 includes a first upper-arm element section QH1 and a first lower-arm element section QL1 that are connected in series with each other. The second leg 32 includes a second upper-arm element section QH2 and a second lower-arm element section QL2 that are connected in series with each other. The high side of the first upper-arm element section QH1 and the high side of the second upper-arm element section QH2 are connected to the step-up side high voltage terminal 25H. The low side of the first upper-arm element section QH1 and the low side of the second upper-arm element section QH2 are respectively connected to the high side of the first lower-arm element section QL1 and the high side of the second lower-arm element section QL2. The low side of the first lower-arm element section QL1 and the low side of the second lower-arm element section QL2 are connected to the step-up side low voltage terminal 25L and to the step-down side low voltage terminal 26L. The element sections QH1, QL1, QH2, and QL2 respectively include: a first upper-arm switch SH1, a first lower-arm switch SL1, a second upper-arm switch SH2, and a second lower-arm switch SL2, each being a semiconductor switching element; diodes DH1, DL1, DH2, and DL2 respectively connected in anti-parallel with the switches SH1, SL1, SH2, and SL2 as anti-parallel diodes; and snubber capacitors CH1, CL1, CH2, and CL2 respectively connected in parallel with the switches SH1, SL1, SH2, and SL2.

The switches SH1, SL1, SH2, and SL2, which are semiconductor switching elements, are insulated gate-type semiconductor switching elements, and more specifically, are n-channel MOSFETs. For each of the switches SH1, SL1, SH2, and SL2, the high-side terminal is a drain and the low-side terminal is a source. In the case where each switch is a p-channel MOSFET, the high-side terminal is the source, and the low-side terminal is the drain. Each switch may be an IGBT instead of a MOSFET. In the case where each switch is an n-channel IGBT, the high-side terminal is a collector, and the low-side terminal is an emitter. In the case where each switch is a p-channel IGBT, the high-side terminal is an emitter, and the low-side terminal is a collector. The diodes DH1, DL1, DH2, and DL2 may be separate diode elements from the switches SH1, SL1, SH2, and SL2, or may be formed on the same semiconductor substrate as the semiconductor switching element, such as in an RC-IGBT. The snubber capacitors CH1, CL1, CH2, and CL2 absorb transient high voltages generated at the time of shut-off of the switches SH1, SL1, SH2, and SL2, thereby contributing to a reduction in turn-off losses of the switches SH1, SL1, SH2, and SL2.

A first end of the main reactor LM1 is connected to a step-down side high-voltage terminal 26H. A first end of the first auxiliary reactor LS1 is connected to a second end of the main reactor LM1. A second end of the first auxiliary reactor LS1 is connected to the low side of the first upper-arm element section QH1 and the high side of the first lower-arm element section QL1. A first end of the second auxiliary reactor LS2 is connected to the second end of the main reactor LM1. A second end of the second auxiliary reactor LS2 is connected to the low side of the second upper-arm element section QH2 and the high side of the second lower-arm element section QL2. The auxiliary reactors LS1 and LS2 are inductors having equal inductance, whereby variations in current flowing through the first leg 31 and the second leg 32 can be suppressed. The main reactor LM1 is an inductor having a larger inductance than the auxiliary reactors LS1 and LS2. The currents flowing through the first and second auxiliary reactors LS1 and LS2 reverse when switches SH1, SL1, SH2, and SL2 are turned off, thereby adjusting the reverse recovery current during switch turn-off and contributing to reduced switching losses. Designing the inductances of the first and second auxiliary reactors LS1 and LS2 to be lower than that of the main reactor LM1 can prevent the time required for the currents flowing through the first and second auxiliary reactors LS1 and LS2 to reverse from becoming excessively long when switches SH1, SL1, SH2, and SL2 are turned off.

The control device 40 includes a switching control unit 41 (SW control unit 41) and a switching unit 42. The control device 40 is mainly configured with a well-known microcomputer (microcontroller) including a CPU, a ROM, a RAM, a flash memory, and the like. For example, the CPU executing a power conversion program installed in the ROM can implement functions of the switching control unit 41 and the switching unit 42 provided in the control device 40. The functions provided by the microcomputer may be implemented by software recorded in a tangible memory device and a computer executing the software, by software alone, by hardware alone, or by a combination thereof. For example, in the case where the microcomputer is provided by an electronic circuit as hardware, the functions may be implemented by a digital circuit including a large number of logic circuits, or by an analog circuit. For example, the microcomputer executes a program stored in a non-transitory tangible storage medium serving as its storage unit. The program includes, for example, a program for a battery control process described later. When the program is executed, a method corresponding to the program is carried out. The storage unit is, for example, a non-volatile memory. The program stored in the storage unit may be updated via a network such as the Internet.

The switching control unit 41 operates the switches SH1, SL1, SH2, and SL2. The switching control unit 41 controls gate drive signals for the switches SH1, SL1, SH2, and SL2 to perform on/off control of the switches SH1, SL1, SH2, and SL2. The gate drive signal takes either an ON command indicating the ON state or an OFF command indicating the OFF state. The switching control unit 41 controls a phase difference in switching control of the switches SH1, SL1, SH2, and SL2 included in the first leg 31 and the second leg 32, and performs switching control for switching the switches SH1, SL1, SH2, and SL2 in a predefined order.

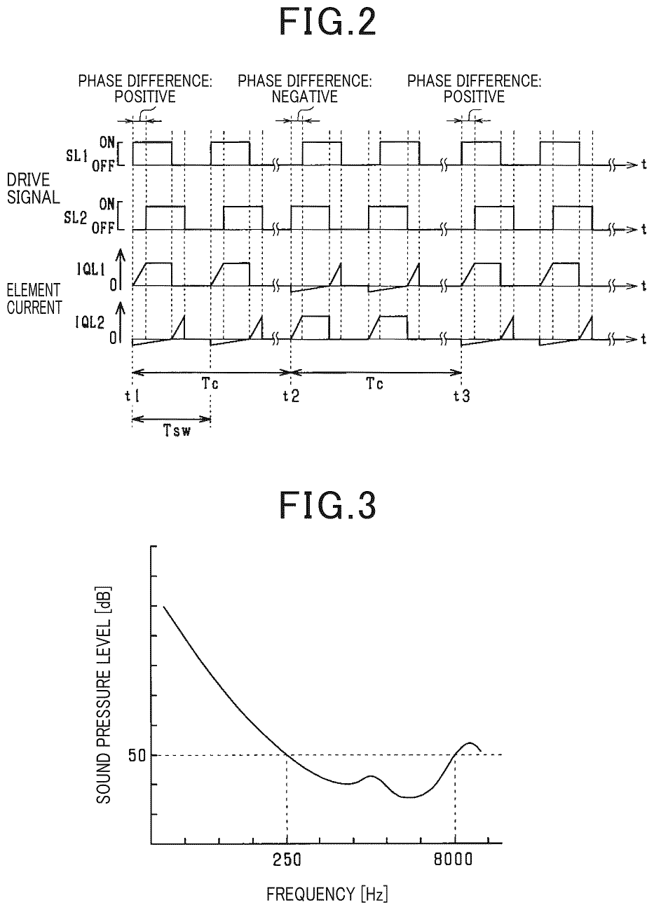

FIG. 2 illustrates gate drive signals for controlling the switches SL1 and SL2 in the first lower-arm element section QL1 and the second lower-arm element section QL2, as well as an element current IQL1 flowing through the first lower-arm element section QL1 and an element current IQL2 flowing through the second lower-arm element section QL2. The element currents IQL1 and IQL2 are illustrated on the same scale, with the current flowing from the drain side to the source side of each of the switches SL1 and SL2 defined as positive, and the current flowing in the conduction direction of each of the diodes DL1 and DL2, which is the reverse direction, defined as negative. The switching control unit 41, for example, switching-controls the switches SL1 and SL2 of the element sections QL1 and QL2 based on the gate drive signals illustrated in FIG. 2. The switching control unit 41 sets a phase difference between the gate drive signal of the first lower-arm switch SL1 and the gate drive signal of the second lower-arm switch SL2, thereby shifting the switching timings of the switches SL1 and SL2. Although not illustrated, the first upper-arm switch SH1 is controlled by an inverted signal relative to the gate drive signal of the first lower-arm switch SL1 by the switching control unit 41. The second upper-arm switch SH2 is controlled by an inverted signal relative to the gate drive signal of the second lower-arm switch SL2. That is, the switching control unit 41 performs switching control so that the first upper-arm switch SH1 and the first lower-arm switch SL1, which constitute the first leg 31, are alternately switched to the ON state with a dead time therebetween. Further, the switching control unit 41 performs switching control so that the second upper-arm switch SH2 and the second lower-arm switch SL2, which constitute the second leg 32, are alternately switched to the ON state with a dead time therebetween. In the present embodiment, one switching period Tsw of each of the switches SH1, SL1, SH2, and SL2 is of the same length.

Further, a process performed by the control device 40 will be described. The first leg 31 is designated as a reference leg, and the second leg 32 is designated as a residual leg. When a second timing for switching the second lower-arm switch SL2 to the ON state is controlled to have a positive phase difference relative to the first timing for switching the first lower-arm switch SL1 to the ON state, the second lower-arm switch SL2 can be switched to the ON state at a timing later than that of the first lower-arm switch SL1. Further, the second upper-arm switch SH2 can be switched to the OFF state at a timing later than that of the first upper-arm switch SH1. In this case, the first leg 31 may be referred to as a leading leg, and the second leg 32 may be referred to as a lagging leg. Further, when the second timing is controlled to have a negative phase difference relative to the first timing, the second lower-arm switch SL2 can be switched to the ON state at a timing earlier than that of the first lower-arm switch SL1. In this case, the first leg 31 may be referred to as a lagging leg, and the second leg 32 may be referred to as a leading leg.

The switching unit 42 performs switching control every predefined switching period Tc. In the present embodiment, the switching period Tc is set to be longer than one switching period Tsw, and specifically, for example, is set to be longer than two switching periods (2×Tsw). It is preferable that the switching period Tc be set to an integer multiple of the switching period Tsw. The switching control is control for switching a leg that includes a semiconductor switching element first switched to the ON state in the switching control. Specifically, the switching unit 42 switches the second timing relative to the first timing between a positive phase difference and a negative phase difference each time the switching period Tc elapses.

When the leg including the semiconductor switching element first switched to the ON state is the first leg 31, the first lower-arm element section QL1 and the second upper-arm element section QH2 constitute a main circuit functioning as a step-up circuit. When the first lower-arm switch SL1 is switched to the ON state, power from the power source 27 is stored in the main reactor LM1, and when the first lower-arm switch SL1 is switched to the OFF state, energy stored in the main reactor LM1 is output to the load 28. The second lower-arm element section QL2 and the first upper-arm element section QH1 constitute an auxiliary circuit for performing soft switching. When the leg including the semiconductor switching element first switched to the ON state is the second leg 32, the second lower-arm element section QL2 and the first upper-arm element section QH1 constitute a main circuit functioning as a step-up circuit. When the second lower-arm switch SL2 is switched to the ON state, power from the power source 27 is stored in the main reactor LM1, and when the second lower-arm switch SL2 is switched to the OFF state, energy stored in the main reactor LM1 is output to the load 28. The first lower-arm element section QL1 and the second upper-arm element section QH2 constitute an auxiliary circuit for performing soft switching.

As illustrated in FIG. 2, during a period from time t1 to time t2, the switching control unit 41 switches the first lower-arm switch SL1 to the ON state at a first timing, and controls a second timing for switching the second lower-arm switch SL2 to the ON state so as to have a positive phase difference relative to the first timing. By controlling the phase difference in this manner, the second upper-arm switch SH2 and the second lower-arm switch SL2 can be switched at timings later than the first upper-arm switch SH1 and the first lower-arm switch SL1. The above phase difference can be determined according to the magnitude of an output voltage required of the power conversion circuit 20. For example, the switching control unit 41 decreases the phase difference as the output voltage required relative to the input voltage increases, thereby increasing a period during which the switches SL1 and SL2 are simultaneously in the ON state. During the period from time t1 to time t2, the leg including the semiconductor switching element first switched to the ON state is the first leg 31 including the first upper-arm switch SH1 and the first lower-arm switch SL1. While switching control is being performed in an order in which the first leg 31 is first subject to switching control, as illustrated in FIG. 2, a positive element current IQL1 flowing through the first lower-arm element section QL1 flows at a higher magnitude and for a longer period as compared with a positive element current IQL2 flowing through the second lower-arm element section QL2. Accordingly, an amount of heat generation in the first lower-arm switch SL1 of the first lower-arm element section QL1 becomes greater than an amount of heat generation in the second lower-arm switch SL2 of the second lower-arm element section QL2.

As illustrated in FIG. 2, when the first lower-arm switch SL1 is switched to the ON state and the first upper-arm switch SH1 is switched to the OFF state, the second upper-arm switch SH2 is ON, and the second lower-arm switch SL2 is OFF. In this case, a current flows from the power source 27 to the main reactor LM1, the first auxiliary reactor LS1, and the first lower-arm switch SL1, whereby the element current IQL1 takes a positive value and increases. The element current IQL2 is negative, and a current flows through the diode DL2. However, this current decreases toward zero. Next, when the second lower-arm switch SL2 is switched to the ON state and the second upper-arm switch SH2 is switched to the OFF state, the first lower-arm switch SL1 is ON, and the first upper-arm switch SH1 is OFF. In this case, the element current IQL1 becomes substantially constant at a positive value, while the element current IQL2 remains negative but increases toward zero.

Next, when the first lower-arm switch SL1 is switched to the OFF state and the first upper-arm switch SH1 is switched to the ON state, the second lower-arm switch SL2 is ON and the second upper-arm switch SH2 is OFF. In this case, the element current IQL1 becomes substantially zero, and the element current IQL2 takes a positive value and increases. Next, when the second lower-arm switch SL2 is switched to the OFF state and the second upper-arm switch SH2 is switched to the ON state, the first upper-arm switch SH1 is ON and the first lower-arm switch SL1 is OFF. In this case, the element currents IQL1 and IQL2 become substantially zero.

A length of the period from time t1 to time t2 corresponds to a length of the switching period Tc. That is, time t2 is the time after the switching period Tc has elapsed from time t1. As illustrated in FIG. 2, at time t2, when the leg including the semiconductor switching element first switched to the ON state is switched from the first leg 31 to the second leg 32 by the switching unit 42, the behaviors of the element current IQL1 and the element current IQL2 are also interchanged.

At time t2, the switching unit 42 controls a second reference timing for switching the second lower-arm switch SL2 to the ON state so as to have a negative phase difference relative to the first timing for switching the first lower-arm switch SL1 to the ON state. Controlling the phase difference in this manner allows the second upper-arm switch SH2 and the second lower-arm switch SL2 to be switched at a timing earlier than the first upper-arm switch SH1 and the first lower-arm switch SL1. During a period from time t2 to time t3, the leg including the semiconductor switching element first switched to the ON state is the second leg 32 including the second upper-arm switch SH2 and the second lower-arm switch SL2. While switching control is being performed in an order in which the second leg 32 is controlled first, as illustrated in FIG. 2, the positive element current IQL2 flowing through the second lower-arm element section QL2 flows at a higher magnitude and for a longer period as compared with the positive element current IQL1 flowing through the first lower-arm element section QL1. Accordingly, an amount of heat generation in the second lower-arm switch SL2 of the second lower-arm element section QL2 becomes greater than an amount of heat generation in the first lower-arm switch SL1 of the first lower-arm element section QL1.

A length of the period from time t2 to time t3 corresponds to a length of the switching period Tc. That is, time t3 is the time after the switching period Tc has elapsed from time t2. At time t3, the switching unit 42 again controls the second timing for switching the second lower-arm switch SL2 to the ON state so as to have a positive phase difference relative to the first timing for switching the first lower-arm switch SL1 to the ON state. Every time the switching period Tc elapses, the phase difference in timing for switching the second upper-arm switch SH2 and the second lower-arm switch SL2 is switched between positive and negative. In this manner, every time the switching period Tc elapses, the leg including the semiconductor switching element first switched to the ON state is alternated between the first leg 31 and the second leg 32. This can mitigate imbalance in heat generation across the switches SH1, SL1, SH2, and SL2 within the power conversion circuit 20.

It is preferable that the switching period Tc be set to a length outside a frequency range in which humans perceive sounds as loud. This can suppress unpleasant noises that may be generated by the switching control. The frequency range in which humans perceive sounds as loud is represented, for example, by an equal-loudness curve illustrated in FIG. 3. In FIG. 3, a vertical axis represents a sound pressure level (in units of dB), and a horizontal axis represents a frequency (in units of Hz). Loudness refers to a perceived magnitude of sound, and even when sound pressure levels are the same, loudness differs depending on the frequency of the sound. An isometric line connecting sound pressure levels at which loudness is equal is the equal-loudness curve illustrated in FIG. 3.

FIG. 3 illustrates a standard equal-loudness level curve defined by the ISO 226 standard. As illustrated in FIG. 3, in the frequency range of greater than 250 Hz and less than 8000 Hz, the sound pressure level on the equal-loudness curve is relatively low, at about 50 dB or lower, whereas in other frequency ranges, the sound pressure level is relatively high, exceeding about 50 dB. Even for sounds at the same sound pressure level, sounds in the frequency range of greater than 250 Hz and less than 8000 Hz have greater loudness compared to sounds in frequency ranges of 250 Hz or lower or 8000 Hz or higher, and are perceived by humans as louder sounds.

As described above, it is preferable that the switching period Tc be set to a length corresponding to a frequency range outside that in which humans perceive sounds as loud. That is, it is preferable that the switching period Tc be set such that the frequency of switching control within the period of the switching period Tc falls outside the frequency range corresponding to the frequency at which humans perceive sounds as loud. As illustrated in FIG. 3, according to the standard equal-loudness level curve, it is preferable that the switching period Tc be set to a length corresponding to a frequency of 250 Hz or lower. Alternatively, it is preferable that the switching period Tc be set to a length corresponding to a frequency of 8 kHz or higher. By setting the switching period Tc in this manner, unpleasant noises that may be generated by the switching control can be suppressed. It should be noted that the equal-loudness curve illustrated in FIG. 3 is presented as an example, and other standards may also be employed.

In order to suppress unpleasant noises that may be generated by the switching control, it is more preferable to set the switching period Tc to a length outside a human audible frequency range (20 Hz to 20 kHz). By setting the switching period Tc to a length corresponding to a frequency of 20 Hz or lower, or to a length corresponding to a frequency of 20 kHz or higher, unpleasant noises that may be generated by the switching control can be more reliably suppressed.

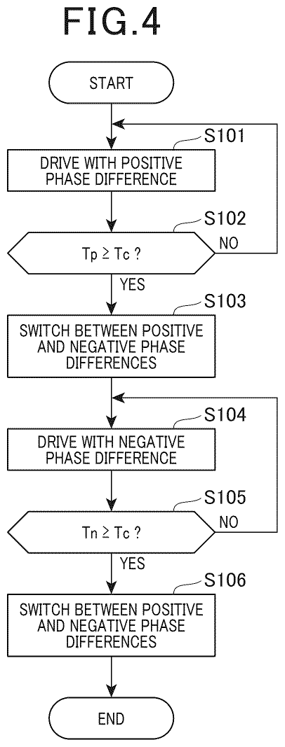

FIG. 4 is a flowchart of the control process for the power conversion circuit 20 performed by the control device 40. The process illustrated in the flowchart of FIG. 4 is implemented by the CPU constituting the control device 40 executing the power conversion program installed in the ROM, and is repeatedly executed at predefined intervals in response to a request for power conversion.

At step S101, the first upper-arm switch SH1 and the first lower-arm switch SL1 are switched based on a first timing, and the second upper-arm switch SH2 and the second lower-arm switch SL2 are switched based on a second timing. Further, control is performed such that the second timing for switching the second lower-arm switch SL2 to the ON state is set with a positive phase difference relative to the first timing for switching the first lower-arm switch SL1 to the ON state. Hereinafter, switching control performed in this order may be referred to as positive phase difference control. While positive phase difference control is being performed, as illustrated during the period from time t1 to time t2 in FIG. 2, the second upper-arm switch SH2 and the second lower-arm switch SL2 are switching-controlled at timings later than the first upper-arm switch SH1 and the first lower-arm switch SL1.

At step S102, it is determined whether an elapsed time Tp from the start of the positive phase difference control is equal to or greater than a switching period Tc. If Tp≥Tc, the process proceeds to step S103. If Tp<Tc, the process returns to step S101, and the positive phase difference control is continued.

At step S103, the phase difference is changed from positive to negative. Then, control is performed such that the second timing for switching the second lower-arm switch SL2 to the ON state is set with a negative phase difference relative to the first timing for switching the first lower-arm switch SL1 to the ON state. Hereinafter, switching control performed in this order may be referred to as negative phase difference control. While negative phase difference control is being performed, as illustrated during the period from time t2 to time t3 in FIG. 2, the second upper-arm switch SH2 and the second lower-arm switch SL2 are switching-controlled at timings earlier than the first upper-arm switch SH1 and the first lower-arm switch SL1.

At step S105, it is determined whether an elapsed time Tn from the start of the negative phase difference control is equal to or greater than the switching period Tc. If Tn<Tc, the process returns to step S104, and the negative phase difference control is continued. If Tn≥Tc, the process proceeds to step S106. At step S106, the phase difference is changed from negative to positive, and the process is terminated.

As described above, the control program for the power conversion circuit 20 executed by the control device 40, and a control method for the power conversion circuit 20 implemented thereby, include, as illustrated in steps S101 and S104, a step corresponding to a switching control step of performing switching control to switch the switches SH1, SL1, SH2, and SL2 in a predefined order by controlling the phase difference when switching these switches included in the plurality of legs (first leg 31, second leg 32). Accordingly, the switches SH1, SL1, SH2, and SL2 can be switched by soft switching. Further, as illustrated in steps S102, S103, S105, and S106, the method includes a switching step of performing switching control to switch the leg including the semiconductor switching element first switched to the ON state in the switching control to another leg every time the switching period Tc elapses. More specifically, at steps S102, S103, S105, and S106, by switching between positive and negative phase differences every time the switching period Tc elapses, the leg that is first subject to switching-control is alternated between the first leg 31 and the second leg 32. This can prevent fixation of a state in which heat generation is concentrated on any one of the switches SH1, SL1, SH2, and SL2 included in the first leg 31 and the second leg 32. As a result, the imbalance in heat generation across the switches SH1, SL1, SH2, and SL2 within the power conversion circuit 20 capable of performing soft switching control can be mitigated.

### Second Embodiment

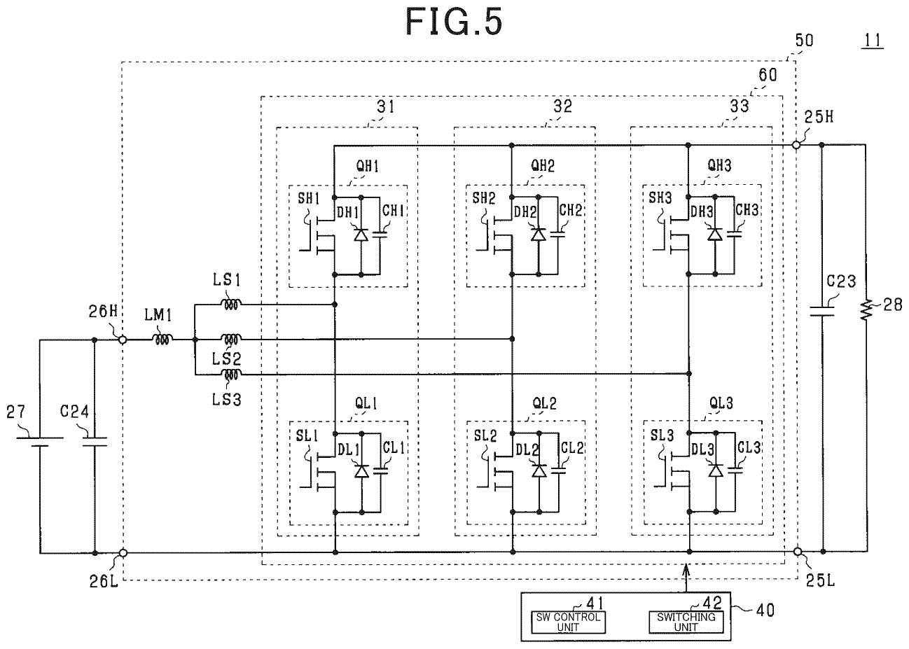

A power conversion system 11 illustrated in FIG. 5 includes a power conversion circuit 50 and a control device 40. The power conversion circuit 50 differs from the switching circuit 30 in that the switching circuit 60 further includes, in addition to the first leg 31 and the second leg 32, a third leg 33 connected in parallel, and further includes a third auxiliary reactor LS3 connected to the third leg 33. The third leg 33 is connected between the second leg 32 and the step-up side capacitor C23 together with the load 28.

The third leg 33 includes a third upper-arm element section QH3 and a third lower-arm element section QL3 connected in series with each other. The element sections QH3 and QL3 are constituted by elements like those of the element sections QH1, QL1, QH2, and QL2. Like the element sections QH1, QL1, QH2, and QL2, the element section QH3 includes a third upper-arm switch SH3, which is a semiconductor switching element, a diode DH3 connected in anti-parallel with the third upper-arm switch SH3, and a snubber capacitor CH3 connected in parallel with the third upper-arm switch SH3. Similarly, the element section QL3 includes a third lower-arm switch SL3, which is a semiconductor switching element, a diode DL3 connected in anti-parallel with the third lower-arm switch SL3, and a snubber capacitor CL3 connected in parallel with the third lower-arm switch SL3. A first end of the third auxiliary reactor LS3 is connected to the second end of the main reactor LM1. A second end of the third auxiliary reactor LS3 is connected to a low side of the third upper-arm element section QH3 and a high side of the third lower-arm element section QL3. The third auxiliary reactor LS3 is an inductor having an inductance equal to that of the first and second auxiliary reactors LS1 and LS2.

The witching control unit 41 operates the switches SH1 to SH3 and SL1 to SL3, and controls gate drive signals for the switches SH1 to SH3 and SL1 to SL3 to perform on/off control of the switches SH1 to SH3 and SL1 to SL3. The switching control unit 41 controls a phase difference in switching control of the switches SH1 to SH3 and SL1 to SL3 included in the first to third legs 31 to 33, and performs switching control for switching the switches SH1 to SH3 and SL1 to SL3 in a predefined order. The third upper-arm switch SH3 is controlled by an inverted signal relative to the gate drive signal for the third lower-arm switch SL3. That is, the switching control unit 41 performs switching control so that the third upper-arm switch SH3 and the third lower-arm switch SL3, which constitute the third leg 33, are alternately switched to the ON state with a dead time therebetween. In the present embodiment, one switching period Tsw of each of the switches SH1, SL1, SH2, SL2, SH3, and SL3 is of the same length.

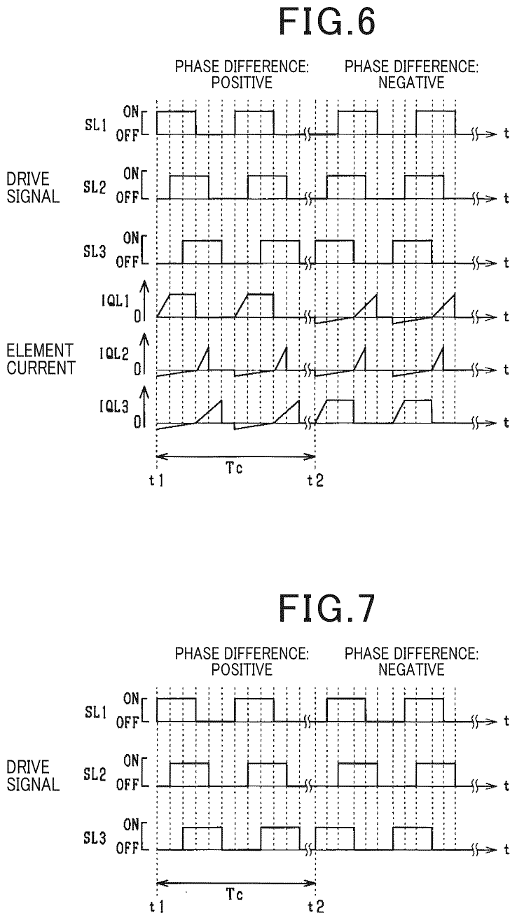

FIG. 6 illustrates gate drive signals for controlling the switches SL1 to SL3 in the first lower-arm element section QL1, the second lower-arm element section QL2, and the third lower-arm element section QL3, and illustrates an element current IQL1 flowing through the first lower-arm element section QL1, an element current IQL2 flowing through the second lower-arm element section QL2, and an element current IQL3 flowing through the third lower-arm element section QL3. The element currents IQL1 to IQL3 are illustrated on the same scale. The switching control unit 41 controls so that switching timings are shifted by setting phase differences among the gate drive signals for the first lower-arm switch SL1, the second lower-arm switch SL2, and the third lower-arm switch SL3. For example, as illustrated in FIG. 6, the switching control unit 41 designates the first leg 31 as a reference leg, and the second leg 32 and the third leg 33 as residual legs, and controls so that a second timing for switching the second lower-arm switch SL2 to the ON state has a positive phase difference (+A) relative to a first timing for switching the first lower-arm switch SL1 to the ON state. The switching control unit 41 switches the third lower-arm switch SL3 to the ON state at a third timing, and controls the third reference timing so as to have a larger positive phase difference (+2A) relative to the first timing. Thus, switching control is performed in the order of the first leg 31, the second leg 32, and the third leg 33. As illustrated in FIG. 6, the positive element current IQL1 flowing through the first lower-arm element section QL1 flows at a higher magnitude and for a longer period as compared with the positive element current IQL2 flowing through the second lower-arm element section QL2 and the positive element current IQL3 flowing through the third lower-arm element section QL3. Accordingly, an amount of heat generation in the first lower-arm switch SL1 of the first lower-arm element section QL1 becomes greater than an amount of heat generation in the second lower-arm switch SL2 of the second lower-arm element section QL2 and in the third lower-arm switch SL3 of the third lower-arm element section QL3.

The switching unit 42 performs switching control every predefined switching period Tc to switch the leg that includes the semiconductor switching element first switched to the ON state in the switching control. For example, as illustrated in FIG. 6, at time t2 when the switching period Tc has elapsed from time t1, the switching unit 42 switches positive and negative phase differences with respect to timings for switching switches SH2, SL2, SH3, and SL3. Specifically, the switching unit 42 controls the second timing for switching the second lower-arm switch SL2 to the ON state such that the phase difference relative to the first timing is shifted from a positive phase difference (+A) to a negative phase difference (−A). The switching unit 42 controls the third reference timing for switching the third lower-arm switch SL3 to the ON state such that the phase difference relative to the first timing is shifted from a positive phase difference (+2A) to a negative phase difference (−2A). As a result, switching control is performed in the order of the third leg 33, the second leg 32, and the first leg 31, thereby enabling switching of the leg including the semiconductor switching element first switched to the ON state. As illustrated in FIG. 6, after time t2, the positive element current IQL3 flowing through the third lower-arm element section QL3 flows at a higher magnitude and for a longer period as compared with the positive element current IQL1 flowing through the first lower-arm element section QL1 and the positive element current IQL2 flowing through the second lower-arm element section QL2. Accordingly, an amount of heat generation in the third lower-arm switch SL3 of the third lower-arm element section QL3 becomes greater than an amount of heat generation in the first lower-arm switch SL1 of the first lower-arm element section QL1 and in the second lower-arm switch SL2 of the second lower-arm element section QL2.

Further, as illustrated in FIG. 7, without changing the timings for switching the second upper-arm switch SH2 to the OFF state and the second lower-arm switch SL2 to the ON state relative to the first timing, switching control may be performed such that the third timing for switching the third lower-arm switch SL3 to the ON state is set to have a negative phase difference (−A) relative to the first timing. As a result, switching control is performed in the order of the third leg 33, the first leg 31, and the second leg 32, and the leg including the semiconductor switching element first switched to the ON state can be switched. From the perspective of suppressing imbalance in heat generation, it is preferable that the switching control be performed such that the leg first subject to switching-control is alternately set without bias among the first leg 31, the second leg 32, and the third leg 33.

### Third Embodiment

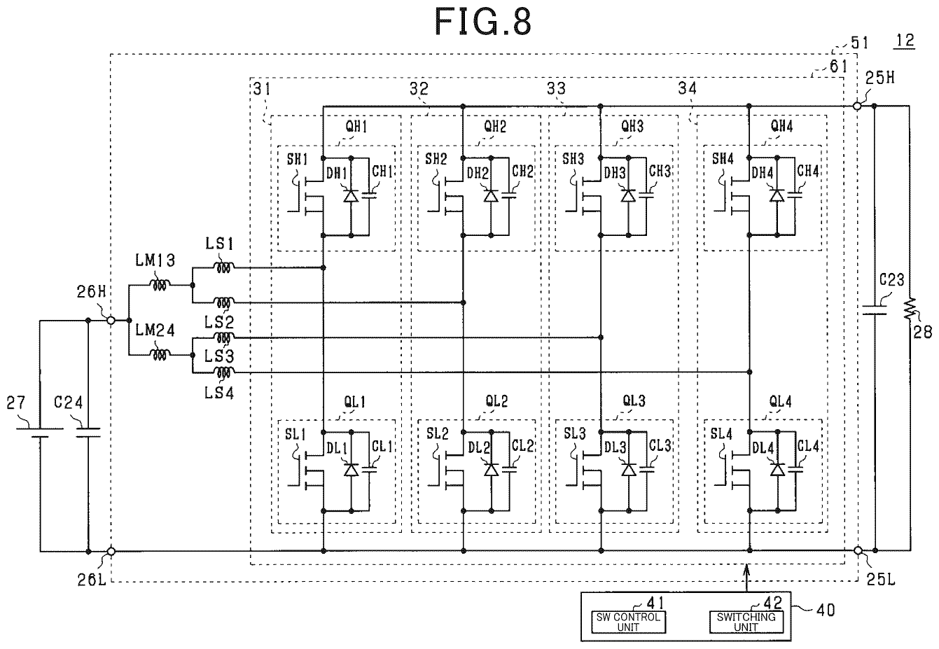

A power conversion system 12 illustrated in FIG. 8 includes a power conversion circuit 51 and a control device 40. The power conversion circuit 51 differs from the switching circuit 30 in that a switching circuit 61 further includes, in addition to the first leg 31 and the second leg 32, a third leg 33 and a fourth leg 34 connected in parallel, in that instead of the single main reactor LM1, two main reactors LM13 and LM24 are provided, and in that a third auxiliary reactor LS3 connected to the third leg 33 and a fourth auxiliary reactor LS4 connected to the fourth leg 34 are further provided. The third leg 33 and the fourth leg 34 are connected between the second leg 32 and the step-up side capacitor C23 together with the load 28.

The third leg 33 includes a third upper-arm element section QH3 and a third lower-arm element section QL3 connected in series with each other. The element sections QH3 and QL3 are constituted by elements like those of the element sections QH1, QL1, QH2, and QL2. Like the element sections QH1, QL1, QH2, and QL2, the element section QH3 includes a third upper-arm switch SH3, which is a semiconductor switching element, a diode DH3 connected in anti-parallel with the third upper-arm switch SH3, and a snubber capacitor CH3 connected in parallel with the third upper-arm switch SH3. Similarly, the element section QL3 includes a third lower-arm switch SL3, which is a semiconductor switching element, a diode DL3 connected in anti-parallel with the third lower-arm switch SL3, and a snubber capacitor CL3 connected in parallel with the third lower-arm switch SL3.

The fourth leg 34 includes a fourth upper-arm element section QH4 and a fourth lower-arm element section QL4 connected in series with each other. The element sections QH4 and QL4 are constituted by elements like those of the element sections QH1 to QH3 and QL1 to QL3. Like the element sections QH1 to QH3 and QL1 to QL3, the element section QH4 includes a fourth upper-arm switch SH4, which is a semiconductor switching element, a diode DH4 connected in anti-parallel with the fourth upper-arm switch SH4, and a snubber capacitor CH4 connected in parallel with the fourth upper-arm switch SH4. Similarly, the element section QL4 includes a fourth lower-arm switch SL4, which is a semiconductor switching element, a diode DL4 connected in anti-parallel with the fourth lower-arm switch SL4, and a snubber capacitor CL4 connected in parallel with the fourth lower-arm switch SL4.

The first and second main reactors LM13 and LM24 are inductors having equal inductance and are connected in parallel with each other. The third and fourth auxiliary reactors LS3 and LS4 are inductors whose inductance is equal to that of the first and second auxiliary reactors LS1 and LS2. The first and second auxiliary reactors LS1 and LS2 are connected in parallel with each other, and the third and fourth auxiliary reactors LS3 and LS4 are connected in parallel with each other.

A first end of the first auxiliary reactor LS1 is connected to the first main reactor LM13, and a second end of the first auxiliary reactor LS1 is connected to the low side of the first upper-arm element section QH1 and the high side of the first lower-arm element section QL1. A first end of the second auxiliary reactor LS2 is connected to the first main reactor LM13, and a second end of the second auxiliary reactor LS2 is connected to the low side of the second upper-arm element section QH2 and the high side of the second lower-arm element section QL2.

A first end of the third auxiliary reactor LS3 is connected to the second main reactor LM24, and a second end of the third auxiliary reactor LS3 is connected to the low side of the third upper-arm element section QH3 and the high side of the third lower-arm element section QL3. A first end of the fourth auxiliary reactor LS4 is connected to the second main reactor LM24, and a second end of the fourth auxiliary reactor LS4 is connected to the low side of the fourth upper-arm element section QH4 and the high side of the fourth lower-arm element section QL4.

The switching control unit 41 operates the switches SH1 to SH4 and SL1 to SL4, and controls gate drive signals for the switches SH1 to SH4 and SL1 to SL4 to perform on/off control of the switches SH1 to SH4 and SL1 to SL4. The switching control unit 41 performs switching control of the first leg 31 and the third leg 33 in the same phase, and performs switching control of the second leg 32 and the fourth leg 34 in the same phase. That is, the switching control unit 41 performs switching control of the first upper-arm switch SH1 and the third upper-arm switch SH3 with gate drive signals of the same phase, and performs switching control of the first lower-arm switch SL1 and the third lower-arm switch SL3 with gate drive signals of the same phase. The switching control unit 41 performs switching control of the second upper-arm switch SH2 and the fourth upper-arm switch SH4 with gate drive signals of the same phase, and performs switching control of the second lower-arm switch SL2 and the fourth lower-arm switch SL4 with gate drive signals of the same phase. The first upper-arm switch SH1, the second upper-arm switch SH2, the third upper-arm switch SH3, and the fourth upper-arm switch SH4 are each controlled by an inverted signal relative to the gate drive signal for the first lower-arm switch SL1, the second lower-arm switch SL2, the third lower-arm switch SL3, and the fourth lower-arm switch SL4, respectively. That is, the switching control unit 41 performs switching control so that the first upper-arm switch SH1 and the first lower-arm switch SL1 constituting the first leg 31 are alternately switched to the ON state with a dead time therebetween. The switching control unit 41 performs switching control so that the second upper-arm switch SH2 and the second lower-arm switch SL2 constituting the second leg 32 are alternately switched to the ON state with a dead time therebetween. The switching control unit 41 performs switching control so that the third upper-arm switch SH3 and the third lower-arm switch SL3 constituting the third leg 33 are alternately switched to the ON state with a dead time therebetween. The switching control unit 41 performs switching control so that the fourth upper-arm switch SH4 and the fourth lower-arm switch SL4 constituting the fourth leg 34 are alternately switched to the ON state with a dead time therebetween. In the present embodiment, one switching period Tsw of each of the switches SH1 to SH4 and SL1 to SL4 is of the same length. The switching control unit 41 may alternatively be configured to perform switching control of the first leg 31 and the third leg 33 with a phase difference of 180 degrees, and switching control of the second leg 32 and the fourth leg 34 with a phase difference of 180 degrees.

Control is performed by the switching control unit 41 so that switching timings are shifted by setting phase differences among gate drive signals for switches SH1 to SH4 and SL1 to SL4. For example, the switching control unit 41 designates the first leg 31 and the second leg 32 as reference legs, and the third leg 33 and the fourth leg 34 as residual legs, and, similarly to FIG. 2, during a period from time t1 to time t2, the switches SL1 and SL3 are switched to the ON state at a first timing, and the switches SL2 and SL4 are switched to the ON state at a second timing. The second timing is controlled to have a positive phase difference relative to the first timing. Although not illustrated, the gate drive signal for the third lower-arm switch SL3 is the same as the gate drive signal for the first lower-arm switch SL1, and the gate drive signal for the first upper-arm switch SH1 is an inverted signal of the gate drive signal for the first lower-arm switch SL1. The gate drive signal for the fourth lower-arm switch SL4 is the same as the gate drive signal for the second lower-arm switch SL2, and the gate drive signal for the second upper-arm switch SH2 is an inverted signal of the gate drive signal for the second lower-arm switch SL2.

The switching unit 42 performs switching control every predefined switching period Tc to switch the leg that includes the semiconductor switching element first switched to the ON state in the switching control. For example, as in FIG. 2, at time t2 when the switching period Tc has elapsed from time t1, the switching unit 42 performs switching control so that the second timing has a negative phase difference relative to the first timing. At time t3 when the switching period Tc has elapsed from time t2, the switching unit 42 again performs switching control so that the second timing has a positive phase difference relative to the first timing. Performing switching control in this manner can mitigate imbalance in heat generation among the switches SH1 to SH4 and SL1 to SL4 included in the power conversion circuit 51.

As illustrated in the second embodiment and the third embodiment, when three or more legs are included, the switching control unit 41 may perform on/off control not for semiconductor switching elements included in all of the legs provided in the switching circuits 60 and 61, but only for semiconductor switching elements included in some of the legs (at least two legs). Suppressing unnecessary switching control can inhibit occurrence of unnecessary switching losses.

### Modifications

In the above embodiments, the element sections QH1 to QH4 and QL1 to QL4 are constituted by switches SH1 to SH4 and SL1 to SL4, diodes DH1 to DH4 and DL1 to DL4 connected in anti-parallel with the respective switches SH1 to SH4 and SL1 to SL4, and snubber capacitors CH1 to CH4 and CL1 to CL4 connected in parallel with the respective switches SH1 to SH4 and SL1 to SL4. The present disclosure is not limited to such a configuration. In an alternative, provision of snubber capacitors CH1 to CH4 and CL1 to CL4 enables absorption of the transient high voltage generated during the turn-off of the switches SH1 to SH4 and SL1 to SL4 connected in parallel therewith, thereby reducing the turn-off losses in these switches SH1 to SL4. In an alternative, the element sections may be configured without the snubber capacitors CH1 to CL4. In an alternative, either the upper-arm element sections QH1 to QH4 or the lower-arm element sections QL1 to QL4 may be constituted only by diodes. For example, QH1 and QH2 illustrated in FIG. 2 may be replaced by diodes connected in the same orientation as DH2 and DL2. In an alternative, as illustrated in the above embodiments, when both the upper-arm element sections QH1 to QH4 and the lower-arm element sections QL1 to QL4 are constituted by semiconductor switching elements and anti-parallel diodes, the switching control unit 41 may be configured to perform on/off control only for either the semiconductor switching elements of the upper-arm element sections or the semiconductor switching elements of the lower-arm element sections, and not perform on/off control for the other. In an alternative, the power conversion circuits 20, 50, and 51 and the control device 40 may be configured to function as a step-down converter.

In the above embodiments, the first to fourth auxiliary reactors LS1 to LS4 are configured with inductors having equal inductance. This allows the effect to be achieved of reducing imbalance in the current flowing through each leg and the effect to be achieved of reducing uneven heat generation between the elements of switches SH1 to SL4. The present disclosure is not limited to such a configuration. In an alternative, the first to fourth auxiliary reactors LS1 to LS4 may be configured with inductors having different inductances. In an alternative, the auxiliary reactor may be provided in at least one of wirings connecting the main reactor and the upper-arm and lower-arm element sections. For example, in the power conversion circuit 20 illustrated in FIG. 1, only one of the first auxiliary reactor LS1 and the second auxiliary reactor LS2 may be provided.

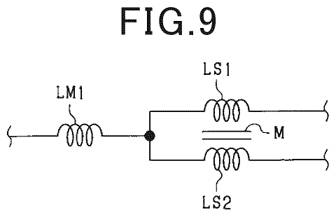

In an alternative, as illustrated in FIG. 9, the first and second auxiliary reactors LS1 and LS2 connected in parallel with each other may be magnetically coupled by winding respective coils on a common iron core M. Similarly, the third and fourth auxiliary reactors LS3 and LS4 connected in parallel with each other may be magnetically coupled by winding respective coils on a common iron core M. This can downsize the first to fourth auxiliary reactors LS1 to LS4, contributing to space savings.

In an alternative, the switching unit 42 may be configured not to perform switching control when a predefined condition is met at a point in time when the switching period Tc has elapsed. For example, the temperatures of the switches SH1, SL1, SH2, and SL2 may be detected, and when a temperature difference among the detected temperatures of the switches SH1, SL1, SH2, and SL2 is equal to or less than a predefined temperature difference threshold, the switching unit 42 may be configured not to perform switching control. The temperature difference among the switches SH1, SL1, SH2, and SL2 refers, for example, to a difference between a highest temperature and a lowest temperature among the detected temperatures of the switches SH1, SL1, SH2, and SL2. The temperatures of the switches SH1, SL1, SH2, and SL2 may be detected, for example, by forming temperature detection elements on semiconductor substrates constituting the switches SH1, SL1, SH2, and SL2.

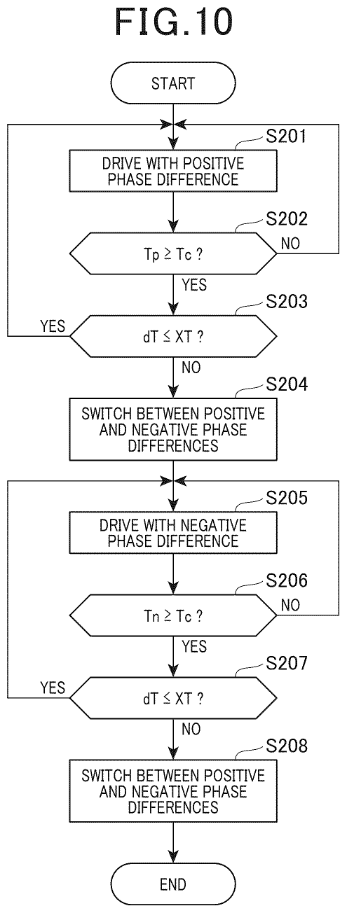

The flowchart illustrated in FIG. 10 differs from the flowchart illustrated in FIG. 4 in that, after steps S202 and S206 for determining whether the switching period Tc has elapsed, steps S203 and S207 are performed to determine whether a difference dT between the highest temperature and the lowest temperature among the detected temperatures of the switches SH1, SL1, SH2, and SL2 is equal to or less than a temperature difference threshold XT. The processes illustrated in steps S201, S202, S204 to S206, and S208 of FIG. 10 are the same as those illustrated in steps S101 to S106 of FIG. 4, and therefore description thereof is omitted. As illustrated in FIG. 10, if Tp≥Tc is determined at step S202, the process flow proceeds to step S203. If it is determined that dT≤XT at step S203, the process flow returns to step S201, and the positive phase difference control is continued without performing switching control. If it is determined that dT>XT at step S203, the process flow proceeds to step S204, and the phase difference is switched between positive and negative. Further, if it is determined that Tp≥Tc at step S206, the process flow proceeds to step S207. If it is determined that dT≤XT at step S207, the process flow returns to step S205, and the negative phase difference control is continued without performing switching control. If it is determined that dT>XT at step S207, the process flow proceeds to step S208, and the phase difference is switched between positive and negative. As described above, configuring the switching unit 42 not to perform switching control when the predefined condition is met at the time when the switching period Tc has elapsed, and setting the predefined condition to suppress unnecessary switching can suppress undesired output variations in the power conversion circuit.

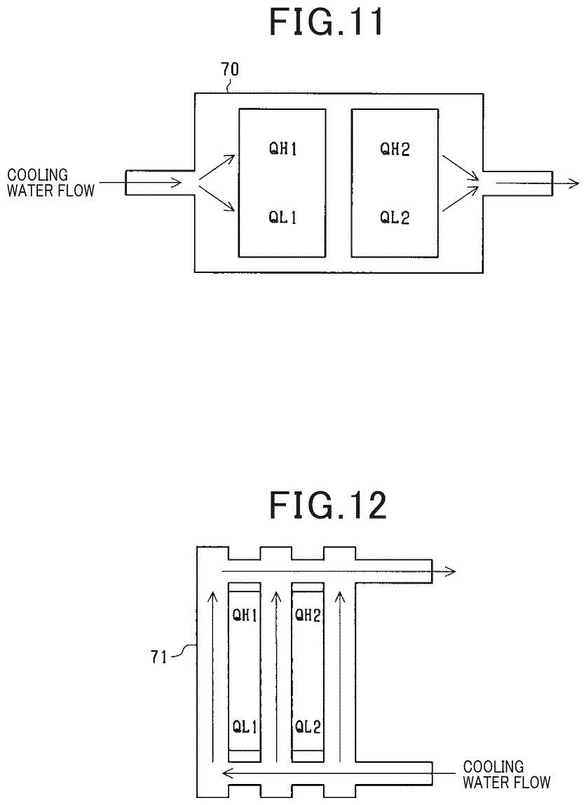

The switching period Tc may take a different value each time switching control is performed or each time a necessity of switching is determined. For example, a switching period Tcp used for comparison with an elapsed time Tp from the start of negative phase difference control, and a switching period Tcn used for comparison with an elapsed time Tn from the start of positive phase difference control may be set to different values. For example, as illustrated in FIG. 11, in a case where the respective element sections Q1 to Q4 are cooled by a planar cooling structure 70 in which a cooling water flow passage is configured such that cooling water (or coolant) flows from the first leg 31 side to the second leg 32 side, a period in which the more readily cooled first leg 31 side is first subject to switching-control may be set longer than a period in which the less readily cooled second leg 32 side is first subject to switching-control. That is, Tcp>Tcn may be set. Further, for example, as illustrated in FIG. 12, in a case where the respective element sections Q1 to Q4 are cooled by a stacked cooling structure 71 in which a cooling water inlet pipe is provided from the second lower-arm element section QL2 side toward the first upper-arm element section QH1 side and a cooling water outlet pipe is provided from the first upper-arm element section QH1 side toward the second upper-arm element section QH2 side, a period in which the more readily cooled second leg 32 side is first subject to switching-control may be set longer than a period in which the less readily cooled first leg 31 side is first subject to switching-control. That is, Tcp<Tcn may be set. From the perspective of suppressing unpleasant noise, it is preferable that the switching periods Top and Ten be set to lengths corresponding to frequencies outside the range in which humans perceive sounds as loud, and more preferably, to lengths corresponding to frequencies outside the human audible frequency range. For example, it is preferable that the switching periods Top and Ten be set to lengths corresponding to frequencies of 250 Hz or lower, or 8 kHz or higher, and more preferably to lengths corresponding to frequencies of 20 Hz or lower, or 20 kHz or higher.

The control device and the method thereof described in the present disclosure may be realized by a dedicated computer provided by configuring a processor and memory programmed to perform one or more functions embodied in a computer program. Alternatively, the control device and the method thereof described in the present disclosure may be realized by a dedicated computer provided by configuring a processor with one or more dedicated hardware logic circuits. Alternatively, the control device and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. A control device for a power conversion circuit, the power conversion circuit being equipped with a switching circuit including a plurality of legs connected in parallel with each other, each of the plurality of legs including an upper-arm element section and a lower-arm element section connected in series to a low side of the upper-arm element section, one element section of the upper-arm element section and the lower-arm element section including a semiconductor switching element and an anti-parallel diode connected in anti-parallel with the semiconductor switching element, and another element section of those upper-arm element section and lower-arm element section including either a semiconductor switching element and an anti-parallel diode or a diode connected in the same direction as the anti-parallel diode, the power conversion circuit being further equipped with a main reactor and an auxiliary reactor, the auxiliary reactor connecting one end of the main reactor and a connection point between the upper-arm element section and the lower-arm element section of at least one of the plurality of legs, the control device comprising:
a switching control unit configured to perform switching control of the semiconductor switching elements included in the plurality of legs, and to control a phase difference between a switching timing at which the semiconductor switching element included in a reference leg among the plurality of legs is switched to an ON state and a switching timing at which a semiconductor switching element included in each of residual legs other than the reference leg and belonging to the same arm as the semiconductor switching element in the reference leg is switched to the ON state; and
a switching unit configured to perform switching control to switch the leg including the semiconductor switching element that is first switched to the ON state, every switching period longer than one switching period of each semiconductor switching element.

2. The control device for the power conversion circuit according to claim 1, wherein
the plurality of legs include a first leg including a first upper-arm element section and a first lower-arm element section, and a second leg including a second upper-arm element section and a second lower-arm element section,
the power conversion circuit comprises a plurality of the auxiliary reactors including a first auxiliary reactor connecting one end of the main reactor and a connection point between the first upper-arm element section and the first lower-arm element section and a second auxiliary reactor connecting one end of the main reactor and a connection point between the second upper-arm element section and the second lower-arm element section, each of the first lower-arm element section and the second lower-arm element section including the semiconductor switching element and the anti-parallel diode,
the first leg is the reference leg, and the second leg is the residual leg,
the switching control unit is configured to control a phase difference between a switching timing at which the semiconductor switching element included in the first lower-arm element section of the first leg is switched to an ON state and a switching timing at which the semiconductor switching element included in the second lower-arm element section of the second leg is switched to an ON state.

3. The control device for the power conversion circuit according to claim 2, wherein the first and second auxiliary reactors have equal inductance.

4. The control device for the power conversion circuit according to claim 2, wherein the first auxiliary reactor and the second auxiliary reactor are magnetically coupled to each other.

5. The control device for the power conversion circuit according to claim 1, wherein the switching unit is configured to set the switching period to a length corresponding to a frequency outside a frequency range in which a human perceives sound as loud.

6. The control device for the power conversion circuit according to claim 1, wherein the switching unit is configured to set the switching period to a length corresponding to 250 Hz or lower in terms of frequency.

7. The control device for the power conversion circuit according to claim 1, wherein the switching unit is configured to set the switching period to a length corresponding to 8 kHz or higher in terms of frequency.

8. The control device for the power conversion circuit according to claim 1, wherein the switching unit is configured to not perform switching control when a predefined condition is met at a point in time when the switching period has elapsed.

9. The control device for the power conversion circuit according to claim 1, wherein the leg includes snubber capacitors connected in parallel with the semiconductor switching elements.

10. The control device for the power conversion circuit according to claim 1, wherein the auxiliary reactor has lower inductance than the main reactor.

11. A control program product for a power conversion circuit, the power conversion circuit being equipped with a switching circuit including a plurality of legs connected in parallel with each other, each of the plurality of legs including an upper-arm element section and a lower-arm element section connected in series to a low side of the upper-arm element section, one element section of the upper-arm element section and the lower-arm element section including a semiconductor switching element and an anti-parallel diode connected in anti-parallel with the semiconductor switching element, and another element section of those upper-arm element section and lower-arm element section including either a semiconductor switching element and an anti-parallel diode or a diode connected in the same direction as the anti-parallel diode, the power conversion circuit being further equipped with a main reactor and an auxiliary reactor, the auxiliary reactor connecting one end of the main reactor and a connection point between the upper-arm element section and the lower-arm element section of at least one of the plurality of legs, the computer program product comprising a non-transitory computer readable storage medium having computer readable program embodied therewith, the computer readable program configured to cause a computer to perform:
a switching control step of performing switching control of the semiconductor switching elements included in the plurality of legs, and to control a phase difference between a switching timing at which the semiconductor switching element included in a reference leg among the plurality of legs is switched to an ON state and a switching timing at which a semiconductor switching element included in each of residual legs other than the reference leg and belonging to the same arm as the semiconductor switching element in the reference leg is switched to the ON state; and
a switching step of performing switching control to switch the leg including the semiconductor switching element that is first switched to the ON state, every switching period longer than one switching period of each semiconductor switching element.
